(19) United States
(12) Patent Application Publication
(10) Pub. No.: US 2003/0227737 A1
(43) Pub. Date: Dec. 11, 2003

(54) Method and apparatus for fabricating a protective layer on a chuck

(75) Inventor: Brian C. Lue, Mountain View, CA (US)

Correspondence Address: Patent Counsel, APPLIED MATERIALS, INC., P.O. Box 450A, Santa Clara, CA, 95052, US

(73) Assignee: Applied Materials, Inc.

(21) Appl. No.: 10/454,775

(22) Filed: Jun. 3, 2003

Related U.S. Application Data
(60) Provisional application No. 60/385,692, filed on Jun. 4, 2002.

(51) Int. Cl. H02H 1/00

(52) U.S. Cl. 361/234

(57) ABSTRACT

Various embodiments of the invention are generally directed to an apparatus for supporting a substrate in a processing chamber. In one embodiment, the invention is directed to a chuck made of a dielectric material sintered with binders and a protective layer disposed on the chuck. The protective layer is made from a dielectric material. In another embodiment, the invention is directed to a method for fabricating a chuck. The method includes providing a chuck having an upper surface and a side peripheral surface, introducing dielectric powder particles into a combustible gas mixture, combusting the dielectric powder particles and the gas mixture together, and propelling the combusted powder particles onto the chuck to form a protective layer over at least one of the upper surface and the side peripheral surface of the chuck.

### CROSS-REFERENCE TO RELATED APPLICATIONS

This application claims benefit of U.S. provisional patent application serial No. 60/385,692, filed Jun. 4, 2002, which is incorporated herein by reference.

### BACKGROUND OF THE INVENTION

1. Field of the Invention

Embodiments of the present invention generally relate to processing semiconductor substrates, and more particularly, to electrostatic chucks configured to retain the substrates during processing.

2. Description of the Related Art

Semiconductor device geometries have dramatically decreased in size since such devices were first introduced several decades ago. Since then, integrated circuits have generally followed the two-year/half-size rule (often called “Moore's Law”), which means that the number of devices that will fit on a chip doubles every two years. Today's wafer fabrication plants are routinely producing devices having 0.13 μm and even 0.1 μm feature sizes, and tomorrow's plants soon will be producing devices having even smaller feature sizes. In the quest to achieve ever-smaller devices, certain issues have become of great concern to the industry.

One such issue relates to contamination that may occur in a semiconductor substrate processing chamber, such as a plasma etching chamber. During processing, reactive gases inside the processing chamber may corrode the electrostatic chuck that retains the substrate, which may cause the electrostatic chuck to disintegrate and cause certain particles making up the electrostatic chuck to be released into the processing chamber, thereby contaminating the chamber.

Therefore, a need exists for an improved apparatus for retaining a substrate in a processing chamber that would be resistant to corrosion caused by reactive gases inside the chamber.

### SUMMARY

Embodiments of the present invention are generally directed to an apparatus for supporting a substrate in a processing chamber. In one embodiment, the apparatus includes a chuck made of a dielectric material sintered with binders and a protective layer disposed on the chuck. The protective layer is made from a dielectric material.

Embodiments of the present invention are also directed to a method for fabricating a chuck. In one embodiment, the method includes providing the chuck having an upper surface and a side peripheral surface, introducing dielectric powder particles into a combustible gas mixture, combusting the dielectric powder particles and the gas mixture together, and propelling the combusted powder particles onto the chuck to form a protective layer over at least one of the upper surface and the side peripheral surface of the chuck.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an example of a plasma etch reactor that includes various embodiments of the invention.

FIG. 2 illustrates a schematic cross sectional view of an electrostatic chuck in accordance with one embodiment of the invention.

FIG. 3 illustrates a plasma gun in accordance with one embodiment of the invention.

FIG. 4 illustrates a detonation gun in accordance with one embodiment of the invention.

FIGS. 5A-C illustrate schematic cross sectional views of one or more masks in accordance with one embodiment of the invention.

### DETAILED DESCRIPTION

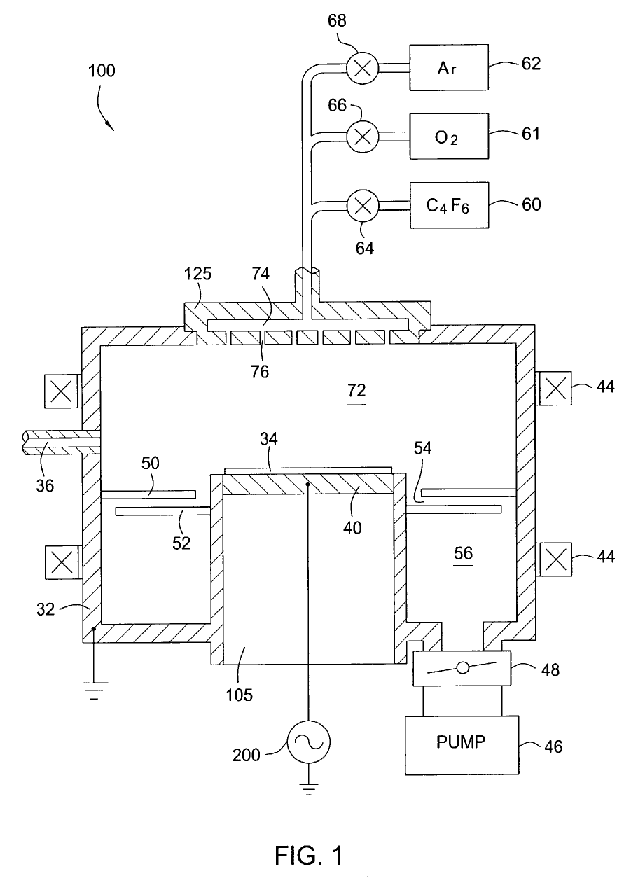

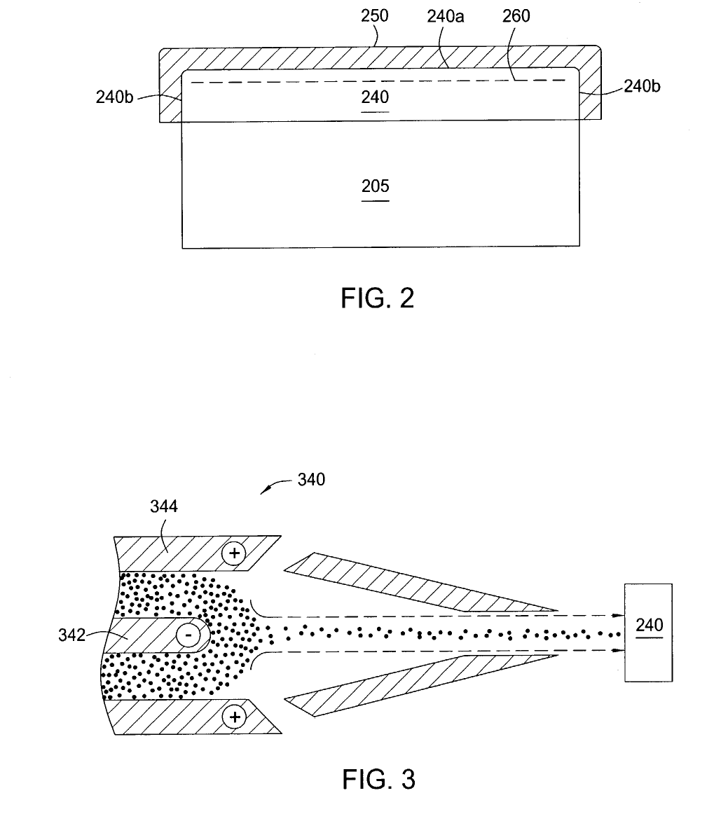

FIG. 1 illustrates an example of a plasma etch reactor 100 that includes various embodiments of the invention. The plasma etch reactor 100 includes a grounded vacuum chamber 32, which may include liners to protect the walls. A substrate 34 is inserted into the chamber 32 through a slit valve opening 36 and is placed on a cathode pedestal 105 with an electrostatic chuck 40 selectively clamping the substrate. Various embodiments of the electrostatic chuck 40 will be described in the following paragraphs with reference to FIGS. 2-5.

Fluid cooling channels may be positioned through the pedestal 105 to maintain the pedestal at reduced temperatures. A thermal transfer gas, such as helium, is supplied to grooves in the upper surface of the pedestal 105. The thermal transfer gas increases the efficiency of thermal coupling between the pedestal 105 and the substrate 34, which is held against the pedestal 105 by the electrostatic chuck 40 or an alternatively used peripheral substrate clamp.

An RF power supply 200, operating at 13.56 MHz, is connected to the cathode pedestal 105 and provides power for generating the plasma while also controlling the DC self-bias. Magnetic coils 44 powered by current supplies surround the chamber 32 and generate a slowly rotating (on the order of seconds and typically less than 10 ms), horizontal, essentially DC magnetic field in order to increase the density of the plasma. A vacuum pump system 46 pumps the chamber 32 through an adjustable throttle valve 48 and a plenum 56. Shields 50, 52 not only protect the chamber 32 and pedestal 105 but also define a baffle 54 and a pumping channel 54 connected to the throttle valve 48.

Processing gases are supplied from gas sources 60, 61, 62 through respective mass flow controllers 64, 66, 68 to a gas distribution plate 125 positioned in the roof of the chamber 32 overlying the substrate 34 and across from a processing region 72. The distribution plate 125 includes a manifold 74 configured to receive the processing gases and communicate with the processing region 72 through a showerhead having a large number of distributed apertures 76, thereby injecting a more uniform flow of processing gases into the processing region 72. An unillustrated VHF power supply, operating at about 162 MHz, may be electrically connected to the gas distribution plate 125 to provide power to the gas distribution plate 125 for generating the plasma.

Other details of the etch reactor 100 are further described in commonly assigned U.S. Pat. No. 6,451,703, entitled “Magnetically Enhanced Plasma Etch Process Using A Heavy Fluorocarbon Etching Gas”, issued to Liu et al. and U.S. Pat. No. 6,403,491, entitled “Etch Method Using A Dielectric Etch Chamber With Expanded Process Window”, issued to Liu et al., which are both incorporated by reference herein to the extent not inconsistent with the invention. Although various embodiments of the invention will be described with reference to the above-described reactor, the embodiments of the invention may also be used in other reactors, such as one described in commonly assigned U.S. Ser. No. 10/028,922 filed Dec. 19, 2001, entitled “Plasma Reactor With Overhead RF Electrode Tuned To The Plasma With Arcing Suppression”, by Hoffman et al., which is also incorporated by reference herein to the extent not inconsistent with the invention.

Various embodiments of the electrostatic chuck 40 will now be described with reference to FIGS. 2-5. FIG. 2 illustrates a schematic cross sectional view of an electrostatic chuck 240 in accordance with one embodiment of the invention. The electrostatic chuck 240 may also be referred to as an insulation layer or a puck. The chuck 240 is disposed on a cathode pedestal 205. The chuck 240 may include an electrically conductive electrode, e.g., mesh layer 260. The chuck 240 further includes a protective layer 250 disposed thereon. More specifically, the protective layer 250 is disposed on an upper surface 240a and a side peripheral surface 240b of the electrostatic chuck 240. A substrate (not shown) is generally disposed on top of the protective layer 250. The cathode pedestal 205 may be made from a metallic material, such as aluminum and the like. The chuck 240 may be made from a dielectric material, such as aluminum oxide sintered with silica binders, such as silicon oxide. The protective layer 250 may be made from a dielectric material, such as alumina (aluminum oxide), aluminum nitride and the like.

The electrically conductive electrode 260 may actually be in the form of a dual-electrode, such as a first electrically conductive mesh layer and a second electrically conductive mesh layer. The first electrically conductive mesh layer may be configured to supply an RF bias voltage to control ion bombardment energy at the surface of the substrate 34, while the second electrically conductive mesh layer may be coupled to a DC voltage source.

Details of the protective layer 250 will now be described in the following paragraphs. As mentioned above, the protective layer 250 may be made from a dielectric material, which has the characteristic of being resistant to corrosion from gases introduced into the chamber. Such gases may include silicon-containing gases, oxygen-containing gases, fluorine-containing gases, nitrogen-containing gases, and the like. The protective layer 250 may have a thickness from about 0.001″ to about 0.020″. Since the protective layer 250 is disposed on the upper surface 240a and the side peripheral surface 240b of the electrostatic chuck 240, the protective layer 250 is configured to protect the electrostatic chuck 240 from being corroded by the reactive gases introduced into the chamber. In one embodiment, the protective layer 250 is made from alumina, while the chuck 240 is made from alumina particles sintered with silica binders and the reactive gases are silicon-containing gases.

The protective layer 250 may be formed on the chuck 240 using a variety of methods, such as plasma glow discharge spraying, flame spraying, electric wire melting, electric-arc melting and detonation gun techniques and the like. FIG. 3 illustrates an exemplary plasma gun 340 that may be used to form the protective layer 250 on the chuck 240. The plasma gun 340 includes a cone-shaped cathode 342 inside a cylindrical anode 344 that forms a nozzle. Other details of the plasma gun 340 may be described in commonly assigned U.S. Pat. No. 6,414,834 entitled “Dielectric Covered Electrostatic Chuck”, issued to Weldon et al., which is incorporated by reference herein to the extent not inconsistent with the invention.

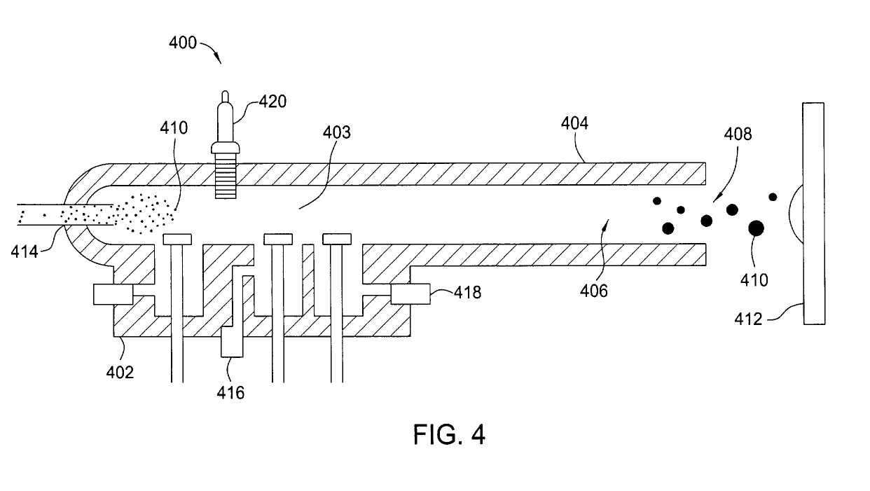

FIG. 4 schematically illustrates a representative detonation gun 400 that may be used to form the protective layer 250 on the chuck 240. The detonation gun 400 has a main body 402 defining an inner combustion chamber 403 and a gun barrel 404 defining an inner passage 406 in communication with combustion chamber 403. The gun barrel 404 includes a nozzle 408 for discharging powder particles 410 onto a workpiece 412, such as the upper surface 240a and the side peripheral surface 240b of the chuck 240. The detonation gun 400 further includes a powder inlet port 414 and two fuel gas inlet ports 416, 418 for injecting a fuel gas mixture of at least one combustible gas. A spark plug 420 extends into the chamber 403 for igniting the fuel gas mixture.

The fuel gas mixture, such as oxygen-acetylene, is ignited to produce a detonation wave which travels along the barrel 404 of the detonation gun 400, where the fuel gas mixture heats the coating material and propels the coating material from the detonation gun 400 and onto the generally planar surface of the workpiece 412. The coating material may be in the form of powder particles 410. In one embodiment, the coating material is made from a dielectric material, such as alumina. Other dielectric materials, such as aluminum nitride, are also contemplated by embodiments of the present invention.

The detonation gun 400 generally utilizes at least two combustible gases selected from the group of saturated and unsaturated hydrocarbons. The group may include acetylene, propylene, methane, ethylene, methyl acetylene, propane, ethane, butadienes, butylenes, butanes, cyclopropane, propadiene, cyclobutane and ethylene oxide. The fuel mixture comprises oxygen and acetylene. A variety of detonation guns having the structure described above or an equivalent structure can be adapted for use in the inventive process. For example, detonation guns that are suitable for the present invention are known under the trade names of D-gun™ and Super D-gun™ manufactured by Praxair S. T., Inc. of Indianapolis, Ind.

In use, a mixture of oxygen and acetylene is fed through ports 416, 418 into the combustion chamber 403 and a charge of powder particles 410 is fed through port 414 via a carrier gas, such as nitrogen or air, into the chamber 402. The powder particles 410 may be made from a dielectric material, such as alumina. The fuel gas is ignited with the spark plug 420 and the resulting detonation wave accelerates the powder particles 410 through the passage 406 of the barrel 404 and heats the powder particles 410 to a temperature above its melting point. The detonation wave typically attains a velocity of about 2800 to 3300 m/s and the particle velocity is typically about 700 to 1000 m/s. The nozzle 408 of the gun barrel 404 is positioned between about 50 to 200 mm from the target surface of the workpiece 412 so that the powder particles 410 spray onto the workpiece 412 to form the protective layer 250 on the surface of the workpiece 412, such as the upper surface 240a or the side peripheral surface 240b of the chuck 240.

In one embodiment of the present invention, the detonation gun process is carried out in pressure and temperature conditions that maintain substantially all of the powder particles 410, e.g., the dielectric material, in the gamma phase. In another embodiment, at least 80% of the powder particles 410 remains in the gamma phase. The gamma phase of powder particles 410 is a distorted or non-ordered crystalline phase of powder particles 410. Allowing the powder particles 410 to transform back to the alpha phase may cause a change in volume, which leads to cracks in the coating. Thus, maintaining the gamma phase throughout the detonation gun process minimizes cracking in the final protective layer. In addition, providing a protective layer with a substantially uniform single phase (i.e., 99% gamma phase) offers a number of advantages. For example, a single-phase protective layer is easier to inspect because it has a generally uniform appearance. A single-phase protective layer also distributes charge more uniformly, which facilitates uniform positioning of the wafer over the electrostatic chuck during processing. Other details of the detonation gun 400 may be described in commonly assigned U.S. Pat. No. 6,175,485 entitled “Electrostatic Chuck And Method For Fabricating The Same”, issued to Krishnaraj et al., which is incorporated by reference herein to the extent not inconsistent with the invention.

As mentioned above, the rapidly expanding mixture of ignited gases in the detonation gun 400 imparts a high kinetic energy detonation wave to propel the protective layer 250 onto the workpiece 412, such as the chuck 240, upon impact. However, when the detonation gun 400 is applied to a corner region of the workpiece 412, the kinetic energy of the detonation wave may be reduced due to the geometrical effect at the corner of the workpiece 412. As a result, a portion of the powdered particles 410 fails to reach a melting point and remains in its solid state, thereby causing pitting to occur near the corner region of the workpiece 412 upon impact.

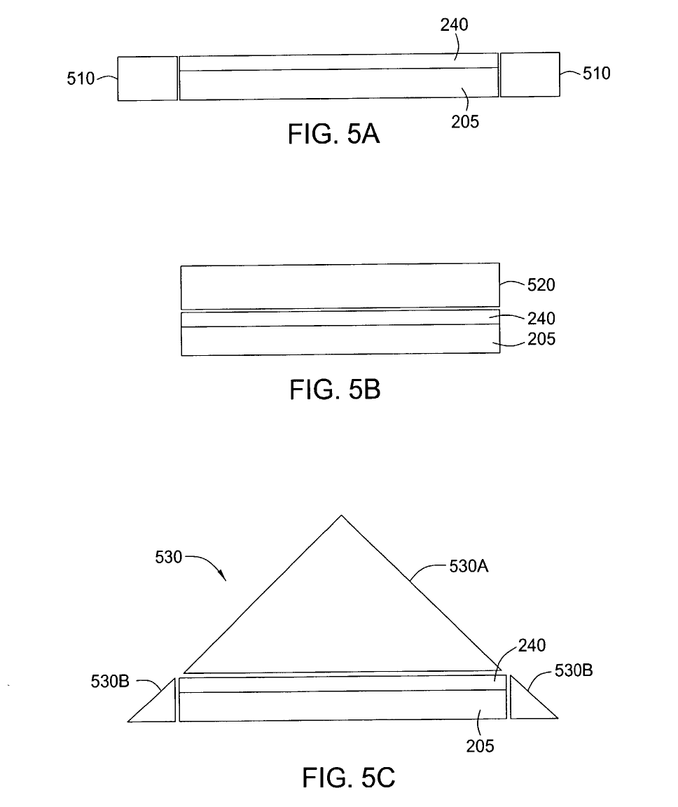

Accordingly, one or more masks (described below with reference to FIGS. 5A-5C) may be disposed on the workpiece 412 to eliminate the reduction of kinetic energy occurring at the corner region of the workpiece 412. The masks provide a uniform surface upon which the protective layer is applied, thereby allowing the detonation wave to maintain a high kinetic energy upon impact with the corner region of the workpiece 412. In this manner, the masks may be used to minimize the occurrence of pitting that typically occurs near the corner region of the workpiece 412. The masks may be made from any material that would be conducive to protecting the workpiece 412 from the coating material being disposed thereon by the gun 400.

FIG. 5A illustrates a schematic cross sectional view of a mask 510 disposed adjacent the side peripheral surface 240b of the electrostatic chuck 240 in accordance with one embodiment of the invention. In one embodiment, mask 510 may be annularly disposed around the chuck 240 and is configured to substantially cover the side peripheral surface 240b. Placing mask 510 adjacent the side peripheral surface 240b provides a uniform surface on the upper surface 240a upon which the protective layer 250 is to be applied. That is, mask 510 positioned adjacent the side peripheral surface 240b allows the coating material to be impelled at the upper surface 240a of the chuck at a high velocity. In this manner, the protective layer 250 may be formed uniformly on the upper surface 240a of the electrostatic chuck 240 without the occurrence of pitting on the upper surface 240a.

FIG. 5B illustrates a schematic cross sectional view of a mask 520 disposed adjacent the upper surface 240a of the electrostatic chuck 240 in accordance with one embodiment of the invention. In one embodiment, mask 520 may have shaped like a disk and is configured to substantially cover the entire upper surface 240a. Placing mask 520 adjacent the upper surface 240a provides a uniform surface on the side peripheral surface 240b upon which the protective layer 250 is to be applied. That is, mask 520 positioned adjacent the upper surface 240a allows the coating material to be impelled at the side peripheral surface 240b of the chuck at a high velocity. In this manner, the protective layer 250 may be formed uniformly on the side peripheral surface 240b of the electrostatic chuck 240 without the occurrence of pitting on the side peripheral surface 240b.

FIG. 5C illustrates a schematic cross sectional view of a mask 530 disposed adjacent the upper surface 240a and the side peripheral surface 240b of the electrostatic chuck 240 in accordance with one embodiment of the invention. In one embodiment, mask 530 may include a top portion 530A and a bottom portion 530B. The top portion 530A may be in the shape of a cone, while the bottom portion 530B may be in the shape of a ring, similar to mask 510. Placing mask 530 adjacent the upper surface 240a and the side peripheral surface 240b provides a uniform surface on the corner regions upon which the protective layer 250 is to be applied. That is, mask 530 positioned adjacent the upper surface 240a and the side peripheral surface 240b allows the coating material to be impelled at the corner regions of the chuck at a high velocity. In this manner, the protective layer 250 may be formed uniformly on the corner regions of the electrostatic chuck 240 without the occurrence of pitting on either the upper surface 240a or the side peripheral surface 240b.

While the foregoing is directed to embodiments of the present invention, other and further embodiments of the invention may be devised without departing from the basic scope thereof, and the scope thereof is determined by the claims that follow.

What is claimed is:

1. An apparatus for supporting a substrate in a processing chamber, comprising:
a chuck comprising a dielectric material sintered with binders; and
a protective layer disposed on the chuck, wherein the protective layer comprises the dielectric material.

2. The apparatus of claim 1, wherein the protective layer is configured to protect the chuck from being corroded by one or more gases introduced into the processing chamber.

3. The apparatus of claim 1, wherein the protective layer comprises aluminum oxide.

4. The apparatus of claim 3, wherein the aluminum oxide is substantially in a gamma phase.

5. The apparatus of claim 1, wherein the chuck comprises aluminum oxide sintered with silica binders.

6. The apparatus of claim 1, wherein the chuck comprises aluminum oxide sintered with silicon oxide.

7. The apparatus of claim 1, wherein the chuck is an electrical chuck.

8. The apparatus of claim 1, wherein the chuck is disposed on a cathode pedestal.

9. The apparatus of claim 1, further comprising means for applying a voltage between the substrate and the chuck to generate a columbic force for retaining the substrate onto the protective layer.

10. The apparatus of claim 1, wherein the protective layer is a detonation-sprayed layer.

11. An apparatus for supporting a substrate in a processing chamber, comprising:
a chuck comprising aluminum oxide sintered with silica binders; and
a protective layer disposed on the chuck, wherein the protective layer comprises aluminum oxide.

12. The apparatus of claim 1, wherein the protective layer is a detonation-sprayed layer.

13. A method for fabricating a chuck, comprising:
providing the chuck having an upper surface and a side peripheral surface;
introducing dielectric powder particles into a combustible gas mixture;
combusting the dielectric powder particles and the gas mixture together; and
propelling the combusted powder particles onto the chuck to form a protective layer over at least one of the upper surface and the side peripheral surface of the chuck.

14. The method of claim 13, wherein propelling the combusted powder particles comprises detonation spraying the combusted powder particles onto the chuck.

15. The method of claim 13, wherein the combusted powder particles are propelled onto the chuck using a detonation gun.

16. The method of claim 13, further comprising disposing one or more masks proximate a corner region of the chuck.

17. The method of claim 16, wherein the masks are configured to enable the dielectric powder particles to propel onto the chuck at a high kinetic energy.

18. The method of claim 13, further comprising disposing a mask adjacent the side peripheral surface of the chuck to form the protective layer on the upper surface of the chuck.

19. The method of claim 18, wherein the mask is annularly disposed around the chuck.

20. The method of claim 18, wherein the mask is configured to substantially cover the side peripheral surface of the chuck.

21. The method of claim 13, further comprising disposing a mask adjacent the upper surface of the chuck to form the protective layer on the side peripheral surface of the chuck.

22. The method of claim 21, wherein the mask is configured to substantially cover the upper surface of the chuck.

23. The method of claim 13, further comprising disposing one or more masks adjacent the upper surface and the side peripheral surface of the chuck to form the protective layer on a corner region of the chuck disposed between the upper surface and the side peripheral surface of the chuck.

24. The method of claim 23, wherein the masks are configured to substantially cover the upper surface and the side peripheral surface of the chuck.
